(19) United States
(12) Patent Application Publication
(10) Pub. No.: US 2017/0133747 A1
(43) Pub. Date: May 11, 2017

(54) ANTENNA MANUFACTURING METHOD AND ANTENNA SYSTEM

(71) Applicants: LE HOLDINGS (BEIJING) CO., LTD., Beijing (CN); Lemobile Information Technology (Beijing) Co., Ltd., Beijing (CN)

(72) Inventors: Bo CHENG, Beijing (CN); Jia HE, Beijing (CN)

(21) Appl. No.: 15/237,437

(22) Filed: Aug. 15, 2016

Related U.S. Application Data
(63) Continuation of application No. PCT/CN2016/088439, filed on Jul. 4, 2016.

(30) Foreign Application Priority Data
Nov. 6, 2015 (CN) 201510758256.3

(51) Int. Cl. H01Q 1/24; H01Q 1/38

(52) U.S. Cl. CPC H01Q 1/243; H01Q 1/38

(57) ABSTRACT

An embodiment of the present disclosure discloses an antenna manufacturing method and an antenna system. The method specifically comprises: spraying a conductive layer on the back of a screen of a mobile terminal to form an antenna body, wherein, the size of the antenna body is matched with the frequency band of an antenna system. The antenna manufacturing method and the antenna system according to the embodiment of the present disclosure may improve the irradiation efficiency of the electromagnetic wave of the antenna system, and widen the bandwidth of the antenna system.

### CROSS-REFERENCE TO RELATED APPLICATIONS

This application is a continuation of International Application No. PCT/CN2016/1088439, filed on Jul. 4, 2016, which is based upon and claims priority to Chinese Patent Application No. 201510758256.3, entitled “ANTENNA MANUFACTURING METHOD AND ANTENNA SYSTEM”, filed on Nov. 6, 2015, the entire contents of which are incorporated herein by reference.

### TECHNICAL FIELD

The present disclosure generally relates to the field of electronic technologies, in particular to an antenna manufacturing method and an antenna system.

### BACKGROUND

Along with the popularization of mobile terminals and the development of intelligence, mobile terminals need to support more and more categories of wireless technologies increasingly. Except supporting mobile communication Cellular network, mobile terminals are needed to be integrated with WIFI (Wireless Fidelity), WIHD (Wireless HD), NPC (Near Field Communication) and MIMO (Multiple-Input Multiple-Output) technologies. The integration of those technologies needs antennas as support, so the quantity of antennas in the mobile terminals increases dramatically.

According to an existing antenna manufacturing method, antennas are manufactured on the frame and on the appearance of the rear housing of a mobile terminal. However, due to numerous categories of antennas in the antenna system and limited space on the frame and on the appearance of the rear housing of the mobile terminal, the manufacturing of antennas is strictly limited by industrial design and mechanical strength, resulting in that it is difficult to achieve the antenna size needed for irradiation in each frequency band, and that the antennas fail to perform effective irradiation, thus reducing the irradiation efficiency of the antenna and further reducing the performance of antenna systems.

### SUMMARY

An embodiment of the present disclosure discloses an antenna manufacturing method and an antenna system for solving a problem of low irradiation efficiency of antennas in the prior art, further overcoming the performance defects of the antenna system improving the irradiation efficiency of the electromagnetic wave of the antenna system, and widening the bandwidth of the antenna system.

An embodiment of the present disclosure discloses an antenna manufacturing method, including:
spraying a conductive layer on the back of a screen of a mobile terminal to form an antenna body, wherein, the size of the antenna body is matched with the frequency band of an antenna system.

An embodiment of the present disclosure discloses a device, including:
a connector and antenna body sprayed on the back of a screen of a mobile terminal;
wherein, the antenna body is connected with a PCB of the mobile terminal through the connector, and the size of the antenna body is matched with the frequency band of an antenna system.

An embodiment of the present disclosure discloses an antenna manufacturing method and an antenna system. On the one hand, in the embodiment of the present, the antenna body is sprayed onto the back of the screen of the mobile terminal in form of the conductive layer; the design of the antenna body is little limited by the industrial design and the mechanical strength, so the antenna body may be sprayed in a specific pattern to meet the size requirements. The antenna body may be sprayed into the antenna size meeting the needs of the irradiation in a frequency band, so relative to the antenna manufacturing solution in the prior art, the antenna body in the embodiment of the present disclosure may fully and effectively perform electromagnetic wave irradiation. Therefore, the embodiment of the present disclosure may improve the electromagnetic wave irradiation efficiency of the antenna system and widen the bandwidth of the antenna system.

On the other hand, relative to the existing solution in which the antennas are manufactured on the frame and on the appearance of the back housing of the mobile terminal, the antenna body in the embodiment of the present disclosure is sprayed on the back of the screen of the mobile terminal, thus saving antenna space in the mobile terminal.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flowchart of an antenna manufacturing method according to an embodiment of the present disclosure.

FIG. 2 is a step flowchart of an antenna manufacturing method according to another embodiment of the present disclosure.

FIG. 3 is a structural view of an antenna system according to an embodiment of the present disclosure.

FIG. 4 is a top view of an antenna system according to the present disclosure.

FIG. 5 is a structural view of an antenna system according to an embodiment of the present disclosure.

### DETAILED DESCRIPTION

To clarify the objectives, technical solutions and advantage of the embodiments of the present disclosure, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, those ordinarily skilled in this field may obtain other embodiments without creative labor, which all shall fall within the protective scope of the present disclosure.

### Method Embodiment 1

The first method of the present disclosure generally discloses an antenna manufacturing method, specifically including the steps as follows.

Spraying a conductive layer on the back of a screen of a mobile terminal to form an antenna body, wherein, the size of the antenna body is matched with the frequency band of an antenna system.

The embodiment of the present disclosure may be applied to the manufacturing of antenna bodies of mobile terminals such that antenna bodies are sprayed as specific shapes upon demands to meet the antenna size needed for the irradiation in a frequency band.

In the embodiment of the present disclosure, the had of the screen of the mobile terminal is sprayed with a conductive layer to form the antenna body. The shape of the antenna body may be set upon demands during spraying, or the shape of the antenna body is designed according to the size of the antenna body corresponding to the frequency band of the antenna system, so that the antenna body with a corresponding size is sprayed in a limited space. For example, if the obtained size of the antenna body corresponding to the antenna frequency band is 10 mm, then the back of the screen of the mobile terminal may be sprayed with an L-shaped antenna body, so the size of the antenna body is 10 mm; for another example, the obtained size of the antenna body corresponding to the antenna frequency band is 15 mm, then the back of the screen of the mobile terminal may be sprayed with an S-shaped antenna body, so the size of the antenna body is 15 mm.

It is understandable that, the L-shaped or S-shaped antenna body sprayed is just an example of the shape of the antenna body in the embodiment of the present disclosure, which cannot be regarded as limiting the shape of the antenna body in the embodiment of the present disclosure. Actually, the above-mentioned antenna body may be sprayed into any shape, for example, — shape, Z shape, wave-form shape, etc. Therefore, the shape of the antenna body may be set by those skilled in this field according to the needed size of the antenna body and the space, capable of being sprayed, of the screen terminal of the mobile terminal. The embodiment of the present disclosure does not specifically define the shape of the antenna body.

In actual use, the size of an antenna and the frequency of the antenna are in a corresponding ratio relationship. For example, the relationship between the size of the antenna and the frequency band of the antenna system meets the following formula: S=C/(2f), wherein, S represents the size of the antenna body; C represents the velocity of light; and f represents the frequency band of the antenna system. This means that the size of the antenna body may be obtained by the above formula.

It is understandable that, the relationship, which meets the formula S=C/(2f), between the size of the antenna and the frequency band of the antenna system is just an example of the relationship the size of the antenna and the frequency band of the antenna system in the embodiment of the disclosure, and cannot be regarded as limit in the relationship between the size of the antenna and the frequency band of the antenna system in the embodiment of the disclosure. Actually, the relationships between the sizes of different types of antennas and the frequency band of the antenna system are different, for example, the size of an antenna may be ¼ wavelength. Therefore, the embodiment of the disclosure does not specifically define the relationship between the size of the antenna and the frequency band of the antenna system.

In this embodiment of the present disclosure, one or more antenna bodies are acceptable, meaning that the back of the screen of the mobile terminal may be sprayed with one or more antenna bodies, for example, the back of the screen of the mobile terminal may be sprayed with one antenna body for supporting mobile communication Cellular, and the back of the screen of the mobile terminal may also be sprayed with two antenna bodies respectively used for supporting WIFI and WIHD technologies.

In an optional embodiment of the present disclosure, a step of spraying a conductive layer on the back of the screen of the mobile terminal to form an antenna body may specifically include: spraying sprayable conductive materials on the back of the screen of the mobile terminal to form an antenna body. Wherein, the sprayable conductive materials are conductive materials capable of being sprayed in a liquidized or powder state, for example ITO (Indium Tin Oxide), silver paste, etc.

In conclusion, the embodiment of the present disclosure discloses an antenna manufacturing method. On the one hand, in the embodiment of the present, the antenna body is sprayed onto the back of the screen of the mobile terminal in form of the conductive layer; the design of the antenna body is little limited by the industrial design and the mechanical strength, so the antenna body may be sprayed in a specific pattern to meet the size requirements. The antenna body may be sprayed into the antenna size meeting the needs of the irradiation in a frequency band, so relative to the antenna manufacturing solution in the prior art, the antenna body in the embodiment of the present disclosure may fully and effectively perform electromagnetic wave irradiation. Therefore, the embodiment of the present disclosure may improve the electromagnetic wave irradiation efficiency of the antenna system and widen the bandwidth of the antenna system.

On the other hand, relative to the existing solution in which the antennas are manufactured on the frame and on the appearance of the back housing of the mobile terminal, the antenna body in the embodiment of the present disclosure is sprayed on the back of the screen of the mobile terminal, thus saving antenna space in the mobile terminal.

### Method Embodiment 2

Refer to FIG. 1, which illustrates a step flowchart of an antenna manufacturing method according to an embodiment of the present disclosure. The method specifically may include the steps as follows.

Step 101: spraying a conductive layer on the back of a screen of a mobile terminal to form an antenna body, wherein, the size of the antenna body is matched with the frequency band of an antenna system.

Step 102: installing a connector on a PCB (Printed Circuit Board) of the mobile terminal.

Step 103: assembling the antenna body and the connector so that the antenna body feeds a signal into the PCB via the connector.

Relative to the method embodiment 1, in this embodiment of the present disclosure, steps 102 and 103 are added. The steps 102 and 103 may be added after the manufacturing of the antenna body. The PCB of the mobile terminal is assembled with the connector so that the antenna body feeds a signal into the PCB via the connector, realizing signal transmission between the antenna body and the mobile terminal.

In this embodiment, the connector may be a middle medium for signal transmission between the antenna body and the PCB, and may be made from conductive materials, for example, conductive foam, conductive cloth or spring metal plate, etc.

In this embodiment of the present disclosure, the step of assembling the antenna body and the connector may specifically include: assembling the connector on the PCB and connecting to the antenna body, which means that the connector is respectively connected with the antenna body and the PCB so that the antenna body may feed signals in the PCB via the connector.

### Method Embodiment 3

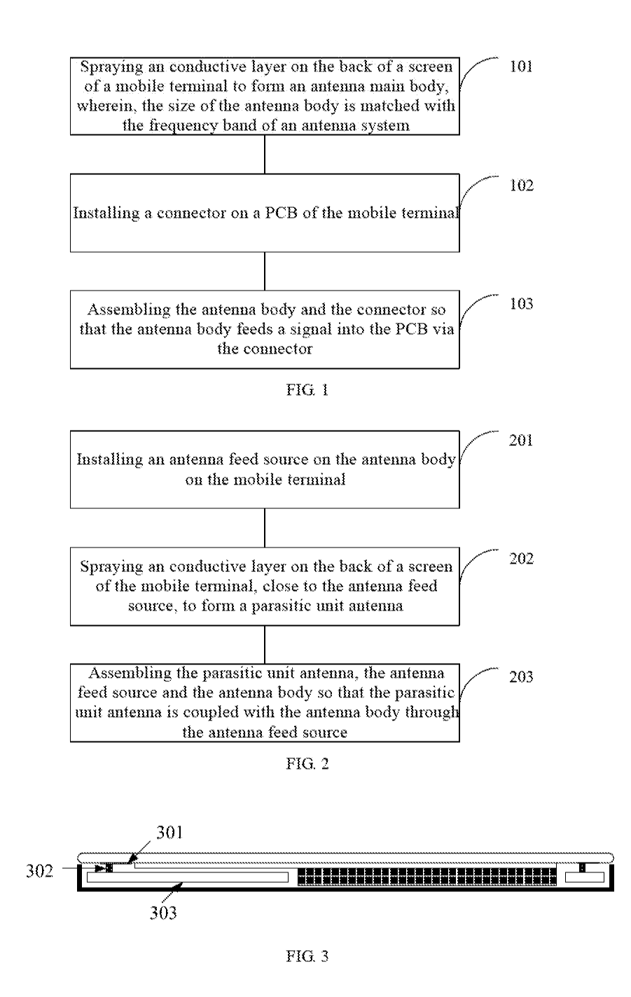

Refer to FIG. 2, which illustrates a step flowchart of an antenna manufacturing method according to another embodiment of the present disclosure. The method specifically may include the steps as follows.

Step 201, installing an antenna feed source on the antenna body on the mobile terminal.

Step 202, spraying a conductive layer on the back of a screen of the mobile terminal, close to the antenna feed source, to form a parasitic unit antenna.

Step 203, assembling the parasitic unit antenna, the antenna feed source and the antenna body so that the parasitic unit antenna is coupled with the antenna body through the antenna feed source.

In this embodiment of the present disclosure, the step of assembling the parasitic unit antenna, the antenna feed source and the antenna body may specifically be as follows: the antenna feed source is installed on the antenna body, and the parasitic unit antenna is close to the antenna feed source, meaning that the antenna feed source is located between the antenna body and the parasitic unit antenna and is not in physical connection with the antenna feed source so the parasitic unit antenna may be coupled with the antenna body via the antenna feed source; the process that the parasitic unit antenna is coupled with the antenna body via the antenna feed source may be specifically as follows: the antenna body is installed with the antenna feed source, and the antenna feed source may irradiate signals in the antenna body to the space in form of electromagnetic wave; the parasitic unit antenna is close to the antenna feed source, so the parasitic unit antenna may receive the electromagnetic waves irradiated by the antenna feed source, generate an induction current according to the received electromagnetic wave and further generate corresponding irradiation, thus increasing the bandwidth of the frequency band corresponding to the antenna body.

In the embodiment of the present disclosure, the back of the screen of the mobile terminal is sprayed with a conductive layer to form the parasitic unit antenna. The shape of the parasitic unit antenna may be set upon demands during spraying, so that a corresponding parasitic unit antenna is sprayed in a limited space. For example, the back of the screen of the mobile terminal is sprayed with an L-shaped parasitic unit antenna, and for another example, the back of the screen of the mobile terminal is sprayed with an S-shaped parasitic unit antenna.

It is understandable that, the L-shaped or S-shaped parasitic unit antenna sprayed is just an example of the shape of the parasitic unit antenna in the embodiment of the present disclosure, which cannot be regarded as limit in the shape of the parasitic unit antenna in the embodiment of the present disclosure. Actually, the above-mentioned parasitic unit antenna may be sprayed into any shape, for example, — shape, Z shape, wave-form shape. Therefore, the shape of the parasitic unit antenna may be set by those skilled in this field upon needs. The embodiment of the present disclosure does not specifically define the shape of the parasitic unit antenna.

In this embodiment of the present disclosure, one or more parasitic unit antennas are acceptable, meaning that the back of the screen of the mobile terminal may be sprayed with one or more parasitic unit antennas, for example, the back of the screen of the mobile terminal may be sprayed with one parasitic unit antenna for expanding the bandwidth of the frequency band corresponding to the antenna body which supports mobile communication Cellular, and the back of the screen of the mobile terminal may also be sprayed with two parasitic unit antennas respectively used for expanding the bandwidth of the frequency band corresponding to the antenna body which supports WIFI and WIHD technologies respectively.

In an optional embodiment of the present disclosure, a step of spraying a conductive layer on the back of the screen of the mobile terminal to form a parasitic unit antenna may specifically include: spraying sprayable conductive materials on the back of the screen of the mobile terminal to form a parasitic unit antenna. Wherein, the sprayable conductive materials are conductive materials capable of being sprayed in a liquidized or powder state, for example ITO, silver paste, etc.

In an optional embodiment of the present disclosure, the antenna body may specially include a common antenna body and/or a sprayed antenna body;
wherein, the sprayed antenna body may be manufactured by the following steps:
spraying a conductive layer on the back of a screen of a mobile terminal, at a position different from the parasitic unit antenna, to form a sprayed antenna body.

Specifically, when the antenna body is a common antenna body, namely the antenna body is an antenna on the framework or on the rear housing of a mobile terminal, the antenna manufacturing method may specially include:
step S1, installing an antenna feed source on the antenna body:
step S2, spraying a conductive layer on the back of a screen of a mobile terminal, close to the antenna feed source, to form a parasitic unit antenna; and
step S3, assembling the parasitic unit antenna, the antenna feed source and the antenna body so that the parasitic unit antenna may expand the bandwidth of the antenna system.

When the antenna body is a sprayed antenna body, the antenna manufacturing method may specifically include:
step A1: spraying a conductive layer on the back of a screen of a mobile terminal to form an antenna body;
step A2, installing an antenna feed source on the antenna body; step A1 spraying a conductive layer on the back of a screen of a mobile terminal, at a position different from the spraying position of the antenna body, and close to the antenna feed source, to form a parasitic unit antenna; and
step A4, assembling the parasitic unit antenna, the antenna feed source and the sprayed antenna body so that the parasitic unit antenna is expanded with the sprayed antenna body through the antenna feed source.

In conclusion, the embodiment of the present disclosure provides an antenna manufacturing method. By spraying the parasitic unit antenna on the back of the screen of the mobile terminal at a position close to the antenna feed source, the parasitic unit antenna is coupled with the antenna body of the mobile terminal via the antenna feed source. Due to the coupling, the parasitic unit antenna generates an induction current and then generates corresponding irradiation to irradiate corresponding electromagnetic waves to the space, thus increasing the electromagnetic waves irradiated by the antenna body to the space. Therefore, the embodiment of the present disclosure can, on the premise of not occupying the internal antenna space of the mobile terminal, add the electromagnetic waves irradiated by the antenna body to the space, namely widening the bandwidth of the frequency band corresponding to the antenna body.

### Device Embodiment 1

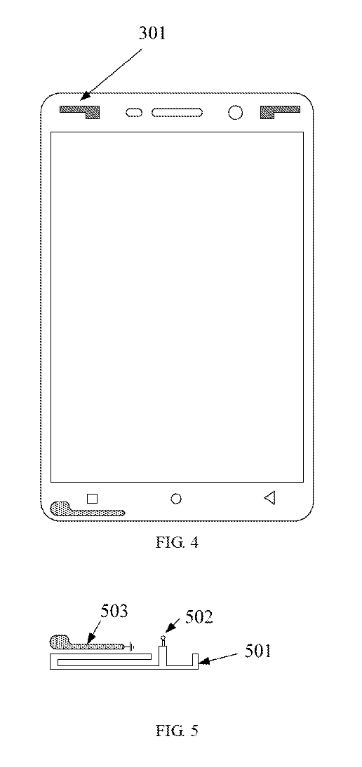

Refer to FIG. 3, which is a structural view of an antenna system according to an embodiment of the present disclosure; Refer to FIG. 4, which is a top view of an antenna system of the present disclosure. The antenna system specifically include:

a connector 302 and an antenna body 301 sprayed on the back of a screen of a mobile terminal, wherein the antenna body is connected with a PCB 303 of the mobile terminal via the connector 302, and the size of the antenna body 301 is matched with the frequency band of the antenna system.

In the embodiment of the present disclosure, the antenna body 301 is sprayed on the back of the screen of the mobile terminal, and is connected with the connector 302 so that the antenna body 301 may feed signals into the PCB 303 of the mobile terminal via the connector 302.

In the embodiment of the present disclosure, the antenna body 301 is sprayed on the back of the screen of the mobile terminal. The shape of the antenna body 301 may be set upon demands during spraying, or the shape of the antenna body 301 is designed according to the size of the antenna body 301 corresponding to the frequency band of the antenna system, so that the antenna body 301 with a corresponding size is sprayed in a limited space. For example, if the obtained size of the antenna body 301 corresponding to the antenna frequency band is 10 mm, then the back of the screen of the mobile terminal may be sprayed with an L-shaped antenna body 301, so the size of the antenna body 301 is 10 mm; for another example, the obtained size of the antenna body 301 corresponding to the antenna frequency band is 10 mm, then the back of the screen of the mobile terminal may be sprayed with an S-shaped antenna body 301, so the size of the antenna body 301 is 15 mm.

In actual use, the size of the antenna body 301 may be obtained by the following formula: S=C/(2f), wherein, S represents the size of the antenna body 301; C represents the velocity of light; and f represents the frequency band of the antenna system.

It is understandable that, the L-shaped or S-shaped antenna body 301 sprayed is just an example of the shape of the antenna body 301 in the embodiment of the present disclosure, which cannot be regarded as limit in the shape of the antenna body 301 in the embodiment of the present disclosure. Actually, an antenna body 301 with any shape may be sprayed, for example, — shape, Z shape, wave-form shape. etc. Therefore, the shape of the antenna body 301 may be set by those skilled in this field according to the needed size of the antenna body 301 and the space, capable of being sprayed, of the screen terminal of the mobile terminal. The embodiment of the present disclosure does not specifically define the shape of the antenna body 301.

In this embodiment of the present disclosure, one or more antenna bodies 301 may be sprayed on the back of the screen of the mobile terminal, for example, the back of the screen of the mobile terminal may be sprayed with one antenna body 301 for supporting mobile communication Cellular, and the back of the screen of the mobile terminal may also be sprayed with two antenna bodies respectively used for supporting WIFI and WIHD technologies.

In an optional embodiment of the present disclosure, the materials of the antenna body may be sprayable conductive materials, wherein, the sprayable conductive materials are conductive materials capable of being sprayed in a liquidized or powder state, for example. ITO, silver paste, etc.

In an embodiment of the present disclosure, the connector may be an middle medium for signal transmission between the antenna body and the PCB, and may be made from conductive materials, for example, conductive foam, conductive cloth or spring metal plate, etc.

### Device Embodiment 2

Refer to FIG. 5, which is a structural view of an antenna system according to another embodiment of the present disclosure. The antenna system may specifically include an antenna body 501, an antenna feed source 502 and a parasitic unit antenna 503 which is sprayed on the back of a screen of a mobile terminal. The antenna feed source 502 is connected with the antenna body 501. The antenna feed source 502 is disposed between the parasitic unit antenna 503 and the antenna body 501.

In this embodiment of the present disclosure, the antenna feed source 502 is installed on the antenna body 501, which means that the antenna feed source 502 is installed on the antenna body 501; the parasitic unit antenna 503 is close to the antenna feed source 502 and is not in physical connection with the antenna feed source 502 so the parasitic unit antenna 503 may be coupled with the antenna body 501 via the antenna feed source 502; the process that the parasitic unit antenna 503 is coupled with the antenna body 501 via the antenna feed source 502 may be specifically as follows: the antenna body 501 is installed with the antenna feed source 502, and the antenna feed source 502 may irradiate signals in the antenna body 501 to the space in form of electromagnetic wave; the parasitic unit antenna 503 is close to the antenna feed source 502, so the parasitic unit antenna 503 may receive the electromagnetic waves irradiated by the antenna feed source 502, generate an induction current according to the received electromagnetic wave and further generate corresponding irradiation, thus increasing the bandwidth of the frequency band corresponding to the antenna body 501.

In the embodiment of the present disclosure, the shape of the parasitic unit antenna 503 may be set upon demands during spraying, so that a corresponding parasitic unit antenna 503 is sprayed in a limited space. For example, an L-shaped parasitic unit antenna 503 may be sprayed, and for another example, an S-shaped parasitic unit antenna 503 may be sprayed.

It is understandable that, the L-shaped or S-shaped parasitic unit antenna 503 sprayed is just an example of the shape of the parasitic unit antenna 503 in the embodiment of the present disclosure, which cannot be regarded as limit in the shape of the parasitic unit antenna 503 in the embodiment of the present disclosure. Actually, the above mentioned parasitic unit antenna 503 may be sprayed into any shape, for example, — shape, Z shape, wave-form shape. Therefore, the shape of the parasitic unit antenna 503 may be set by those skilled in this field upon needs. The embodiment of the present disclosure does not specifically define the shape of the parasitic unit antenna 503.

In this embodiment of the present disclosure, one or more parasitic unit antennas 503 may be sprayed on the back of the screen of the mobile terminal, for example, the back of the screen of the mobile terminal may be sprayed with one parasitic unit antenna 503 for expanding the bandwidth of the frequency band corresponding to the antenna body which supports mobile communication Cellular, and the back of the screen of the mobile terminal may also be sprayed with two parasitic unit antennas respectively used for expanding the bandwidth of the frequency band corresponding to the antenna body which supports WIFI and WIHD technologies respectively.

In an optional embodiment of the present disclosure, the materials of the parasitic unit antenna 503 may be sprayable conductive materials, wherein, the sprayable conductive materials are conductive materials capable of being sprayed in a liquidized or powder state, for example, ITO, silver paste, etc.

In an optional embodiment of the present disclosure, the antenna body 501 may specially include a common antenna body and/or a sprayed antenna body;
wherein, the sprayed antenna body may be manufactured by the following steps;
spraying a conductive layer on the back of a screen of a mobile terminal, at a position different from the parasitic unit antenna, to form a sprayed antenna body.

The system embodiment is basically the same as the method embodiments and therefore is simply described. Related contents may be seen in the related description of the method embodiments.

The device embodiment described above is schematic, wherein units described as separable parts may be or may be not physically separated, and components displayed as units may be or may be not physical units, which means that the units may be positioned at one place or distributed on a plurality of network units. Some or all modules may be selected to fulfill the objective of the solution in the embodiment upon actual demands. Those ordinarily skilled in this field may understand and implement the present disclosure without creative work.

Finally, it should be noted that, the above embodiments are used to describe instead of limiting the technical solution of the present disclosure; although the above embodiments describe the present disclosure in detail, those ordinarily skilled in this field shall understand that they may modify the technical solutions in the above embodiments or make equivalent replacement on some or all technical characteristics of the present disclosure; those modifications or replacement and the corresponding technical solutions do not depart from the spirit and scope of the technical solutions of the above embodiments of the present disclosure.

What is claimed is:

1. An antenna manufacturing method, comprising:
spraying a conductive layer on the back of a screen of a mobile terminal to form an antenna body, wherein, the size of the antenna body is matched with the frequency band of an antenna system.

2. The manufacturing method according to claim 1, wherein said method also comprises:
installing a connector on a PCB of the mobile terminal; and
assembling the antenna body and the connector so that the antenna body feeds a signal into the PCB via the connector.

3. An antenna system comprising a connector and an antenna body sprayed on the back of a screen of a mobile terminal;
wherein, the antenna body is connected with a PCB of the mobile terminal through the connector, and the size of the antenna body is matched with the frequency band of an antenna system.

4. The antenna system according to claim 3, wherein materials of the antenna body are sprayable conductive materials.

5. The antenna system according to claim 3. wherein materials of the connector are conductive materials.

6. An antenna system, comprising an antenna body, an antenna feed source and a parasitic unit antenna sprayed on the back of a screen of a mobile terminal; the antenna feed source being connected with the antenna body, and the antenna feed source being positioned between the parasitic unit antenna and the antenna body.

7. The antenna system according to claim 6, wherein the antenna body comprises a common antenna body or a sprayed antenna body which is formed by spraying a conductive layer on the back of a screen of a mobile terminal at a position different from the parasitic runt antenna.

8. An antenna manufacturing method for manufacturing the antenna according to claim 3, wherein the method comprises:
installing an antenna feed source on the antenna body on the mobile terminal;
spraying a conductive layer on the back of a screen of the mobile terminal, close to the antenna feed source, to form a parasitic unit antenna; and
assembling the parasitic unit antenna, the antenna feed source and the antenna body so that the parasitic unit antenna is coupled with the antenna body through the antenna feed source.

9. The manufacturing method according to claim 8, wherein the antenna body comprises a common antenna body or a sprayable antenna body;
wherein, the sprayed antenna body is manufactured by the following steps:
spraying a conductive layer on the back of a screen of a mobile terminal, at a position different from the parasitic unit antenna, to form a sprayed antenna body.
